(19) United States
(12) Patent Application Publication
(10) Pub. No.: US 2018/0330278 A1
(43) Pub. Date: Nov. 15, 2018

(54) PROCESSES AND TECHNIQUES FOR MORE EFFECTIVELY TRAINING MACHINE LEARNING MODELS FOR TOPICALLY-RELEVANT TWO-WAY ENGAGEMENT WITH CONTENT CONSUMERS

(71) Applicant: TAYGO Inc., San Carlos, CA (US)

(72) Inventors: Sepi GHAJAR, Mountain View, CA (US); Alberto D'SOUZA, Belmont, CA (US)

(73) Assignee: TAYGO Inc., San Carlos, CA (US)

(21) Appl. No.: 15/960,142

(22) Filed: Apr. 23, 2018

Related U.S. Application Data
(60) Provisional application No. 62/503,832, filed on May 9, 2017.
(60) Provisional application No. 62/551,085, filed on Aug. 28, 2017.

(51) Int. Cl. G06N 99/00

(52) U.S. Cl. CPC G06N 99/005; H04L 67/10

(57) ABSTRACT

This relates to processes and techniques for more effectively training machine learning models (i.e., via unsupervised, semi-supervised, and/or supervised training) with relation to a specific context (e.g., products, services, brands, etc.), and more specifically, to processes and techniques—and a system for facilitating such processes and techniques—for more effectively training machine learning models by leveraging the principles of content development and distribution in content marketing operations as well as two-way engagement with content consumers for the purpose of continuously improving the quality of two-way engagement (e.g. conversation) and increasing the engagement around specific topics. In one example process, a system can receive content. The system can analyze the content to identify one or more key phrases and one or more entities, wherein the one or more key phrases and the one or more entities correspond to one or more topics. The system can then generate one or more interaction points based on the one or more key phrases, one or more entities, and one or more topics. After generating the one or more interaction points, the system can insert the one or more interaction points into the content and distribute the content with the one or more inserted interaction points to consumers. The system can then receive interaction data, which represents interactions of the one or more consumers with the content and the one or more interaction points. After, the system generates metrics or analytics based on the interaction data, and trains one or more machine learning models using the metrics or analytics.

### CROSS-REFERENCE TO RELATED APPLICATIONS

This application claims priority from U.S. Provisional Application No. 62/503,832 titled “A platform for development, hosting and deploying on-demand/launch-on-the-fly dynamic/micro Apps/Components/Widgets, made of reusable templates/components and can be triggered via a text message or from inside of another app or website,” filed on May 9, 2017, and U.S. Provisional Application No. 62/551,085 titled “Marketplace for AI Plug-ins and Micro Apps,” filed on Aug. 28, 2017, both of which are hereby incorporated by reference in their entirety for all purposes.

### FIELD

This relates to processes and techniques for more effectively training machine learning models (i.e., via unsupervised, semi-supervised, and/or supervised training) with relation to a specific context (e.g., products, services, brands, etc.), and more specifically, to processes and techniques—and a system for facilitating such processes and techniques—for more effectively training machine learning models by leveraging the principles of content development and distribution in content marketing operations as well as two-way engagement with content consumers for the purpose of continuously improving the quality of two-way engagement (e.g. conversation) and increasing the engagement around specific topics.

### BACKGROUND

The present era is a time of high-volume content production and distribution on the world wide web, such as on digital touchpoints, social media networks, blogs, messaging platforms, in-app plugins, mobile apps, etc. Further, there is a growing demand from content consumers for the ability to instantly communicate and interact with content providers in an on-the-go and real-time fashion. As used herein, content providers can include persons, organizations, and/or businesses that distribute/publish content, as well as business sales teams, customer success teams, customer support teams, etc. Similarly, the need for instant engagement and live interaction with content consumers is on the rise for advertising and marketing operations in order to more efficiently receive content consumer feedback, and thus provide content consumers with more engaging, effective, and useful content. This instant engagement and live interaction with content consumers is referred to as “two-way engagement.” However, there is currently a lack of two-way engagement strategies and built-in solutions in the content production and distribution marketplace that fulfill these needs, and existing two-way engagement platforms fall short of providing effective, cost-efficient, intelligent, and real-time solutions to meet the needs of content consumers, content providers, and the advertising/marketing operations described above.

One reason for the slow adoption of real-time two-way engagement platforms that provide content consumers with the ability to instantly communicate and interact with content providers and advertising/marketing operations is the high cost of implementing such platforms. For example, in order to provide real-time two-way engagement with content consumers, content providers and advertising/marketing operations currently hire large content consumer messaging support teams or acquire and implement expensive artificial intelligence (“AI”) learning platforms/models (e.g., machine learning platforms/models). Moreover, human-based engagement and interactions with content consumers makes data consolidation and analytics much more difficult and time-consuming because the data must be handled manually. Additionally, each individual in human-based engagement teams (e.g., content consumer messaging support teams) has a bandwidth or limit per unit and thus is not a rapidly scalable solution.

Accordingly, content providers and advertising/marketing operations have turned to machine learning platforms/models to provide content consumers with a two-way engagement experience, but current strategies for training machine learning platforms/models—such as feeding content to the machine learning platforms/models from large unorganized pools of content—are inefficient and do not sufficiently train the machine learning platforms/models to accurately and effectively respond to specific questions or requests regarding specific content subject matter. Thus, two-way engagement platforms that rely on these current strategies for training machine learning platforms/models have been found to have low success rates in responding to content consumer questions or requests, which is not enough to assure content consumer satisfaction. As such, the high costs of customization, implementation, and maintenance of existing two-way engagement platforms, as well as the low success rates of current machine learning platforms/models due to inefficient and ineffective training strategies, reduce content providers' and advertising/marketing operations' return on investment (“ROI”)—meaning that their growth will become increasingly expensive.

Thus, there is a need for more effective, cost-efficient, intelligent, and/or real-time processes and techniques for training machine learning platforms/models—and a system for facilitating such processes and techniques—so that, for example, real-time two-way engagement platforms can more accurately interpret and respond to content consumer questions and requests as well as provide more engaging and relevant content (e.g., via guided engagement) that can enhance content consumer knowledge at minimal effort. In addition to solving the problems discussed above, such processes and techniques for training machine learning models can can solve a significant problem in computer science and natural language processing—Named Entity Recognition (“NER”).

In summary, NER requires a large amount of properly annotated data to achieve high confidence scores, wherein confidence scores are determined based on properly finding all the entities in a text and properly determining how these entities relate to each other. By establishing a universal relational model with entities as the basis, the processes and techniques mentioned above (and described in greater detail herein) can design higher level models in content (e.g., physical presentation of entities), topics (e.g., statistical distributions of entities in content), intention (e.g., querying on entity data sets), behavior (e.g., statistical functions of interest in entities and predicted actions), demographics (e.g., statistical distributions of entity types), and identities (e.g., federated entities) that are structurally well supported and thus increase the ability of all models to generate higher confidence scores in decisions, predictions, and classification. Accordingly, these processes and techniques mentioned above can seamlessly integrate the process of NER annotation into the natural content development, distribution, and interaction lifecycle, and thus can increase the quality and success of real-time two-way engagement with content consumers (e.g., by improving natural language processing/understanding, natural language generation, etc.).

Not only can these processes and techniques provide solutions to machine learning model issues such as NER, they can help content providers and advertising/marketing operations improve their content creation, distribution, engagement, and analytics, as well as the chances of achieving their goals (i.e., via effective and guided engagement). For example, these processes and techniques can guide content consumers—via topically-relevant two-way engagement—to perform certain actions that content providers and/or advertising/marketing operations want content consumers to perform (e.g., signing up for certain online services, signing up for certain newsletters, purchasing certain products, making reservations at certain restaurants, visiting certain websites, etc.). Moreover, these processes and techniques can continue to improve the guided engagement of content consumers by dynamically modifying two-way engagement platforms and the two-way engagement experience they provide to content consumers.

### SUMMARY

Processes and techniques for more effectively training machine learning models (i.e., via unsupervised, semi-supervised, and/or supervised training) with relation to a specific context (e.g., products, services, brands, etc.), and more specifically, to processes and techniques—and a system for facilitating such processes and techniques—for more effectively training machine learning models by leveraging the principles of content development and distribution in content marketing operations as well as two-way engagement with content consumers for the purpose of continuously improving the quality of two-way engagement (e.g. conversation) and increasing the engagement around specific topics are described herein. In one example process, a system can receive content. The system can analyze the content to identify one or more key phrases and one or more entities, wherein the one or more key phrases and the one or more entities correspond to one or more topics. The system can then generate one or more interaction points based on the one or more key phrases, one or more entities, and one or more topics. After generating the one or more interaction points, the system can insert the one or more interaction points into the content and distribute the content with the one or more inserted interaction points to consumers (e.g., via one or more channels). The system can then receive interaction data, which represents interactions of the one or more consumers with the content and the one or more interaction points. After, the system generates metrics or analytics based on the interaction data, and trains one or more machine learning models using the metrics or analytics.

### BRIEF DESCRIPTION OF THE DRAWINGS

FIG. 1 illustrates a content development and distribution system for topically-relevant two-way engagement with content consumers according to various examples.

FIG. 2 illustrates a block diagram of a server system according to various examples.

FIG. 3 illustrates a block diagram of the functions of the server system shown in FIG. 2 according to various examples.

FIG. 4 illustrates an exemplary process implemented by a content development and distribution system for topically-relevant two-way engagement with content consumers according to various examples.

FIG. 5 illustrates an exemplary chat engagement interface overlaying a portion of content according to various examples.

FIG. 6A illustrates a block diagram of an exemplary process for training the content development and distribution system machine learning models as well as exemplary results of the training.

FIG. 6B illustrates a block diagram of exemplary functions of the process for training the content development and distribution system machine learning models shown in FIG. 6A according to various examples.

### DETAILED DESCRIPTION

In the following description of examples, reference is made to the accompanying drawings in which it is shown by way of illustration specific examples that can be practiced. It is to be understood that other examples can be used and structural changes can be made without departing from the scope of the various examples.

This relates to processes and techniques for more effectively training machine learning models (i.e., via unsupervised, semi-supervised, and/or supervised training) with relation to a specific context (e.g., products, services, brands, etc.), and more specifically, to processes and techniques—and a system for facilitating such processes and techniques—for more effectively training machine learning models by leveraging the principles of content development and distribution in content marketing operations as well as two-way engagement with content consumers for the purpose of continuously improving the quality of two-way engagement (e.g. conversation) and increasing the engagement around specific topics. In one example process, a system can receive content. The system can analyze the content to identify one or more key phrases and one or more entities, wherein the one or more key phrases and the one or more entities correspond to one or more topics. The system can then generate one or more interaction points based on the one or more key phrases, one or more entities, and one or more topics. After generating the one or more interaction points, the system can insert the one or more interaction points into the content and distribute the content with the one or more inserted interaction points to consumers. The system can then receive interaction data, which represents interactions of the one or more consumers with the content and the one or more interaction points. After, the system generates metrics and/or analytics based on the interaction data.

As used in this specification, a “channel” is a digital platform, network, or touchpoint or an implementation of a digital communication protocol which persons, businesses, organizations, or other entities use to communicate. There are several types of channels. For example, a channel can be a one-to-many social media channel (e.g., Facebook, Instagram, Twitter, Snapchat, YouTube, Reddit, LinkedIn, Pinterest, etc.), a one-to-one private messaging channel (e.g., Facebook Messenger, Twitter Private Messaging, SMS, WhatsApp, Telegram, WeChat, Line, Slack, etc.), a many-to-many group messaging channel (e.g., Facebook Messenger, Slack, WeChat, Line, Blog Center, Email, etc.), and/or a static webpage channel.

### System Overview

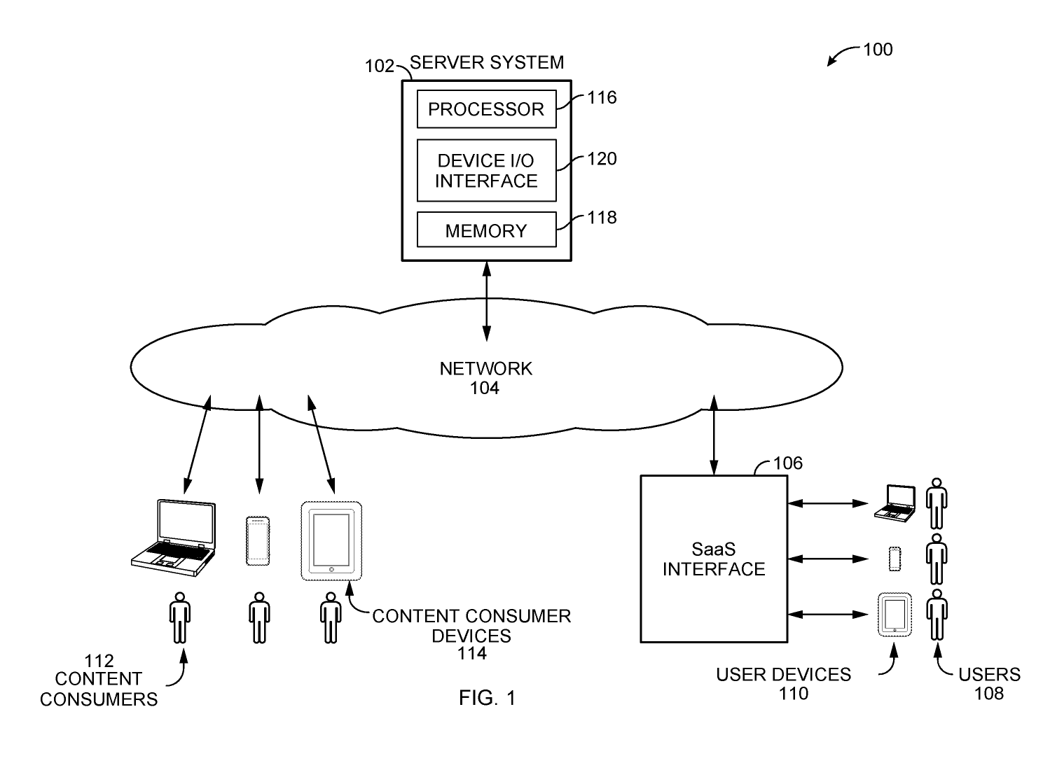

FIG. 1 illustrates a content development and distribution system 100 (“system 100”) for topically-relevant two-way engagement with content consumers according to various examples. In some examples, system 100 can include server system 102, network 104, Software as a Service (“SaaS”) interface 106, users 108, user devices 110, content consumers 112, and content consumer devices 114. In some examples, users 108 on user devices 110 can communicate with server system 102 via SaaS interface 106 to create, modify, upload, and distribute content (e.g., blogs, webpages, messages, etc.), as well as to generate, modify, and distribute topically-relevant two-way engagement mechanisms that can be used for topically-relevant two-way engagement with content consumers.

In some examples, SaaS interface 106 resides on server system 102 and can be accessed by user devices 104 via network 102. For example, user devices 110 can include any electronic device, such as a mobile phone, tablet computer, portable media player, desktop computer, laptop computer, or the like, and can communicate with server system 102 through network 104, which can include the Internet, an intranet, or any other wired or wireless public or private network. In some examples, in order to communicate with server system 102 via SaaS interface 106, users 108 must create a user account, which may comprise user information (e.g., name, profession, company, location, etc. of users 108).

In some examples, SaaS interface 106 can provide a web application that includes one or more interface views with tools and applications that allow users 108 to create, upload, modify, and distribute content, generate, modify, and insert topically-relevant two-way engagement mechanisms (e.g., conversational and live interaction chat engagements) for their content, and/or view content consumer engagement and/or interactions with their content and/or the two-way engagement mechanisms. In some examples, at least one of the interface views provided by the SaaS interface 106 is a channel setup and registry interface view. In some examples, another interface view provided by the SaaS interface 106 is a two-way engagement mechanism view. In some examples, another interface view provided by the SaaS interface 106 is a content consumer engagement and/or interactions view. In some examples, users 108 can access SaaS interface via third-party content development and distribution systems.

As mentioned above, in some examples, users 108 on user devices 110 can communicate with server system 102 via SaaS interface 106 to distribute content (over network 104) that they create, modify, and/or upload with inserted topically-relevant two-way engagement mechanisms. For example, using SaaS interface 106, users 108 may distribute content with topically-relevant two-way engagement mechanisms over network 104 to various types of channels, such as a one-to-many social media channel (e.g., Facebook, Instagram, Twitter, Snapchat, YouTube, Reddit, LinkedIn, etc.), a one-to-one private messaging channel (e.g., Facebook Messenger, Twitter Private Messaging, SMS, WhatsApp, Telegram, etc.), a many-to-many group messaging channel (e.g., Facebook Messenger, Slack, WeChat, Line, Blog Center, Email, etc.), and/or a static webpage channel. In some examples, users 108 may choose to distribute content with topically-relevant two-way engagement mechanisms over network 104 to only one type of channel (e.g., only to one-to-many social media channels). In other examples, users 108 may choose to distribute content with topically-relevant two-way engagement mechanisms over network 104 to more than one type of channel (e.g., to one-to-many social media channels, one-to-one private messaging channels, and static webpage channels).

After server system 102 distributes/publishes content, content consumers 112 may access, view, and interact with the distributed/published content (and with any topically-relevant two-way engagement mechanisms distributed with the content) on consumer devices 114 via network 104. For example, content consumer devices 114 can include any electronic device, such as a mobile phone, tablet computer, portable media player, desktop computer, laptop computer, or the like, and can access, view, and interact with distributed/published content (and with any topically-relevant two-way engagement mechanisms distributed with the content) through network 104, which as explained above can include the Internet, an intranet, or any other wired or wireless public or private network.

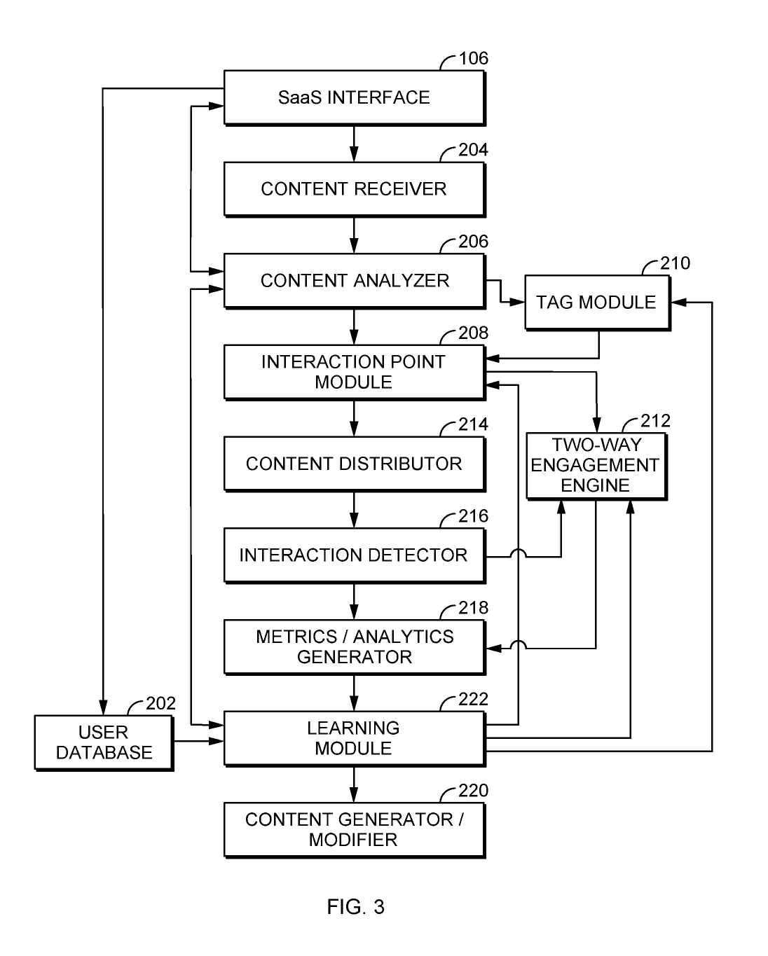

In some examples, server system 102 may receive interaction data via network 104. Interaction data may represent information regarding content consumers 112 and their engagement and/or interactions with the content and/or the topically-relevant two-way engagement mechanisms. For example, interaction data received by server system 102 may include session data (e.g., the time content consumers 112 spend viewing distributed content and/or specific portions of the distributed content), click data (e.g., where and what content consumers 112 click on the content, where and what content consumers 112 click on the two-way engagement mechanisms, etc.), consumer source history, private data (e.g., data such as race, ethnicity, gender, sexual orientation, etc. anonymously shared by content consumers 112 and/or authorized third-party providers), and public data regarding content consumers 112 and content consumer devices 114 (e.g., public demographic data and/or specifications, operating system, browser, IP-address, etc. of content consumer devices 114). Server system 102 may associate received interaction data with the specific channels content consumers 112 accessed the distributed content on. In some examples, server system 102 may then process, analyze, and utilize collected interaction data. Additional examples describing server system 102's processing, analysis, and utilization of interaction data are discussed in more detail below with respect to FIGS. 3-5.

In some examples, server system 102 may preserve the cross-device state of content consumers 112 interactions and/or conversations with topically-relevant two-way engagement mechanisms distributed/published with content. For example, if content consumers 112 switch from one content consumer device to another and are viewing and/or accessing content viewed on a previous content consumer device, server system 102 will process and preserve the history of the content consumers 112 previous interactions and/or conversations for further engagement. In some examples, server system 102 may preserve the cross-channel state of content consumers 112 interactions and/or conversations with topically-relevant two-way engagement mechanisms distributed/published with content. For example, if content consumers 112 switch from accessing and/or viewing content via one channel and subsequently access and/or view the same content via another channel, server system 102 will process and preserve the history of the content consumers 112 previous interactions and/or conversations from the first channel for further engagement with the content via the subsequent channel.

In some examples, server system 102 is capable of automatically performing (i.e., without input from users 108) some of the features described above. For example, server system 102 may automatically create, modify, and/or distribute content. Additionally or alternatively, server system 102 may generate and/or modify topically-relevant two-way engagement mechanisms. Additional features that server system 102 may automatically perform are discussed in further detail below with respect to FIGS. 3-6B.

In some examples, server system 102 may include one or more processors 116, memory 118, and device I/O interface 120. Server system 102 can be implemented on one or more standalone data processing devices or a distributed network of computers. In some examples, server system 102 can employ various virtual devices and/or services of third party service providers (e.g., third-party cloud service providers) to provide the underlying computing resources and/or infrastructure resources of server system 102. For example, server system 102 can employ the scalable server systems of Amazon Web Services. Although server system 102 is illustrated as a single server in FIG. 1, one of ordinary skill in the art would appreciate that server system 102 can comprise any number of servers necessary to perform the server system 102 processes and functions disclosed herein.

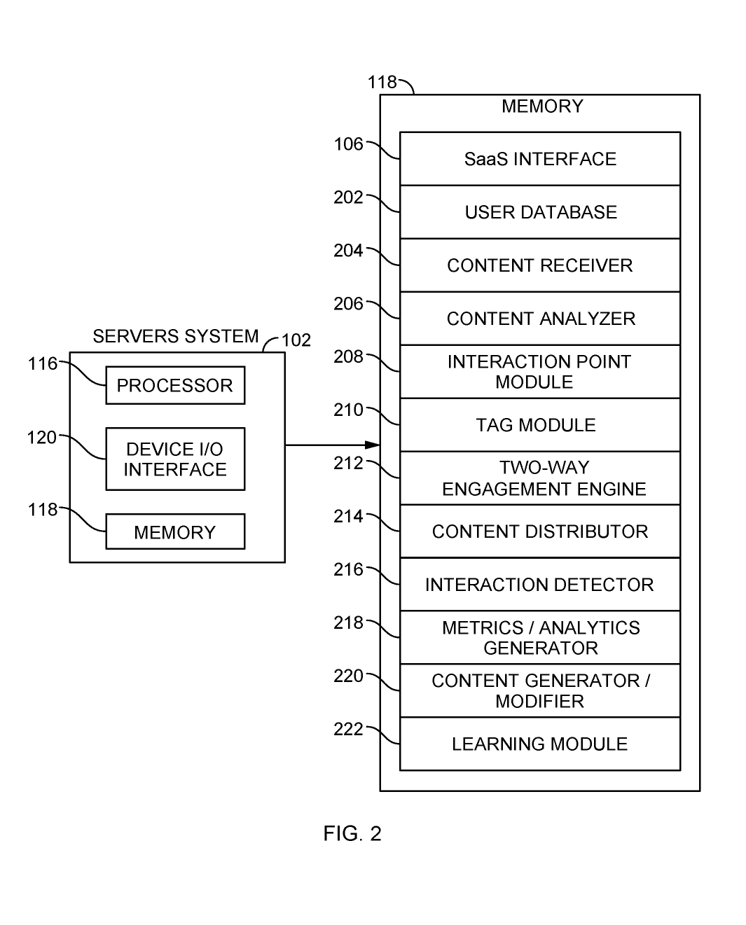

FIG. 2 illustrates a block diagram of a server system 102 according to various examples. As shown, server system 102 can include one or more processors 116, memory 118, and device I/O interface 120. Device I/O interface 120 can facilitate device input and output processing for server system 102. For example, device I/O interface 120 can facilitate user devices 110 and/or content consumer devices 114 input and output processing for server system 102. The one or more processors 116 can utilize memory 118 to execute the instructions stored therein. Memory 118 may include random access memory (RAM), including but not limited to volatile RAM (e.g., DRAM, SRAM) and non-volatile RAM (e.g., NAND). Memory 118 may further include computer-readable storage media. The computer-readable storage media are, for example, tangible and non-transitory. For example, memory 118 can include high-speed random access memory and can also include non-volatile memory, such as one or more magnetic disk storage devices, flash memory devices, or other non-volatile solid-state memory devices. In some examples, the computer-readable storage media of memory 118 store instructions for performing the methods and processes described herein. In some examples, memory 118 can store SaaS interface 106, user database 202, content receiver 204, content analyzer 206, interaction point module 208, tag module 210, two-way engagement engine 212, content distributor 214, interaction detector 216, metrics/analytics generator 218, content generator/modifier 220, and learning module 222.

FIG. 3 illustrates a block diagram of the functions of the server system shown in FIG. 2 according to various examples. Specifically, FIG. 3 illustrates how the server system 102 modules stored in memory 118 interact with one another. SaaS interface can include instructions for providing a web application that includes one or more interface views with tools and applications that allow users 108 to create, upload, modify, and distribute content, generate, modify, and insert topically-relevant two-way engagement mechanisms for their content, and/or view content consumer engagement and/or interactions with their content and/or two-way engagement mechanisms. In general, SaaS interface 106 can include instructions for receiving input from users 108, relaying the input to one or more server system 102 modules so that the input may be processed, and outputting (e.g., displaying) server system 102 outputs.

User database 202 can include instructions for receiving and storing data, information, and content from SaaS interface 106. For example, user database 202 can include instructions for storing user accounts (which may comprise user information such as the names, professions, companies, locations, demographics, etc. of users 108), user content (i.e., content created and/or modified by users 108 via SaaS interface 106), legacy content (i.e., older content created by users 108 prior to creating a user account and subsequently uploaded via SaaS interface 106 and/or content created and/or modified by users 108 using one or more third-party content development systems), and additional content provided by users 108 (e.g., third-party content such as documents, articles, books, video, audio, other forms of media, etc. uploaded by users 108 via SaaS interface 106). User database 202 can further include instructions for relaying the data, information, and/or content it stores to learning module 222.

Content receiver 204 can include instructions for receiving content over network 104. For example, content receiver 204 can include instructions for receiving content over network 104 that is created, modified, and/or uploaded via SaaS interface 106. Additionally or alternatively, content receiver 204 can include instructions for receiving content over network 104 that is created, modified, and/or uploaded via one or more third-party content development and distribution platforms.

Content analyzer 206 can include instructions for analyzing content received by content receiver 204 to identify one or more key phrases and/or one or more entities, as well as one or more topics (e.g., subject matter of at least a portion of content) to which they correspond. “Entities” are proper nouns and proper names that refer to real-world and/or fictional objects like people, places, companies, or products. Entities can also be explicit measurements such as dates and times and quantifiable amounts like numbers, bytes, currency, etc. “Key phrases” are one or more words that describe, identify, and/or distinguish one or more nouns (i.e., key phrases are noun descriptors). In some examples, entities can be subsets of key phrases, so a key phrase might consist of one or more entities and/or descriptors or could simply be an entity. In some examples, key phrases are also iterable in that they are a continuously detectable set of descriptors of preceding or following key phrases.

Content analyzer 206 can further include instructions for receiving users 108 input from SaaS interface 106. For example, content analyzer 206 can include instructions for receiving input from users 108 representing an approval and/or rejection of one or more identified entities and/or key phrases. Alternatively or additionally, content analyzer 206 can include instructions for receiving users 108 input defining a semantic relationship between one or more entities and a portion of content, one or more other entities, and/or one or more key phrases. Alternatively or additionally, content analyzer 206 can include instructions for receiving users 108 input defining a semantic relationship between one or more key phrases and a portion of content, one or more other key phrases, and/or one or more entities. Further, content analyzer 206 can include instructions for relaying the users 108 input it receives from SaaS interface 106 to learning module 222.

Tag module 210 can include instructions for tagging content received by content receiver 204 with one or more tags and/or for facilitating the tagging of content received by content receiver 204 with one or more tags by users 108 via SaaS interface 106. Tag module 210 can further include instructions for tagging content based on one or more key phrases, one or more entities, and/or one or more topics identified by content analyzer 206. In some examples, tags may represent searchable metadata. For example, tags may represent searchable metadata that is topically related to the content on which it is tagged. Additionally or alternatively, tags may represent searchable metadata versions, alternatives, mentions, references, other names, related words, etc. of the key phrases and/or entities identified by content analyzer 206.

Interaction point module 208 can include instructions for generating one or more interaction points based on one or more key phrases, one or more entities, and/or one or more topics identified by content analyzer 206. Interaction point module 208 can further include instructions for generating one or more interaction points based on one or more tags tagged on content by tag module 210. Interaction point module 208 can further include instructions for generating one or more interaction points based on one or more intents (predefined by system 100 and/or created by users 108). Interaction point module 208 can further include instructions for inserting one or more interaction points into content that has been analyzed by content analyzer 206. For example, interaction point module 208 can include instructions for plugging in and/or embedding one or more interaction points into content that has been analyzed by content analyzer 206. Additionally or alternatively, interaction point module 208 can include instructions for associating one or more interaction points with at least a portion of content.

Two-way engagement engine 212 can include instructions for generating one or more two-way engagement mechanisms based on one or more interaction points generated by interaction point module 208. For example, two-way engagement engine 212 can include instructions for generating one or more chat engagements, video engagements, audio engagements, and/or virtual reality engagements based on one or more interaction points generated by interaction point module 208. Two-way engagement engine 212 can further include instructions for inserting one or more two-way engagement mechanisms into content that contains one or more inserted interaction points. For example, two-way engagement engine can further include instructions for plugging in and/or embedding one or more two-way engagement mechanisms (e.g., one or more chat engagements) into content that contains one or more inserted interaction points. Two-way engagement engine 212 can further include instructions for inserting one or more two-way engagement mechanisms such that once content is distributed/published (as explained in further detail below), the one or more two-way engagement mechanisms can overlay at least a portion of content in response to content consumers 112 activating/interacting with one or more inserted interaction points via content consumer devices 114.

Two-way engagement engine 212 can further include instructions for generating two-way engagement mechanism data based on one or more interaction points generated by interaction point module 208 for the one or more two-way engagement mechanisms it generates. For example, two-way engagement engine 212 can include instructions for generating chat engagement data, video engagement data, audio engagement data, and/or virtual reality engagement data based on one or more interaction points generated by interaction point module 208. In some examples, chat engagement data may include text, audio, and/or video, and/or links to webpages, documents, audio files, video files, and/or any other resources available over a network.

Two-way engagement engine 212 can further include instructions for processing interaction data received by interaction detector 216 (explained in further detail below), generating two-way engagement mechanism data based on interaction data it has processed, and/or performing one or more actions based on interaction data it has processed. For example, two-way engagement engine 212 can further include instructions for processing text entered by content consumers 112 into one or more chat engagements (e.g., content consumers 112 questions, responses, requests, etc.), generating chat engagement data based on the processed text (e.g., responses to content consumers 112 questions, responses, requests, etc.), and/or performing one or more actions based on the processed text (e.g., make a reservation, place an order for a product, etc.).

In some examples, two-way engagement engine 212 can include instructions for processing interaction data (e.g., using natural language processing (“NLP”)) to detect one or more intents of content consumers 112 and/or to extract one or more entities from the interaction data. Intents can be predefined by system 100 and/or created by users 108. Additionally, intents can define a link between interaction data received by interaction detector 216, two-way engagement mechanism data generated by two-way engagement engine 212, and/or actions performed by two-way engagement engine 212. In some examples, two-way engagement engine 212 can include instructions for generating two-way engagement mechanism data (e.g., using natural language generation (“NLG”)) based on the one or more detected intents of content consumers 112 and/or the one or more extracted entities. In some examples, two-way engagement engine 212 can include instructions for performing one or more actions based on the one or more detected intents of content consumers 112 and/or the one or more extracted entities. In some examples, two-way engagement engine 212 can further include instructions for generating two-way engagement mechanism data using NLG based on one or more actions it performs and/or attempts to perform.

Content distributor 214 can include instructions for distributing/publishing content with one or more inserted interaction points and/or two-way engagement mechanisms over network 104, and for broadcasting the content with the one or more inserted interaction points and/or two-way engagement mechanisms over network 104 to one or more channels. Content distributor 214 can further include instructions for translating the content into one or more templates that are compatible with the one or more channels and allow content consumers 112 visiting the one or more channels to access, view, understand (e.g., via content language translation), and/or interact with the distributed/published content over network 104 (as well as the one or more interaction points and/or two-way engagement mechanisms within the content).

Interaction detector 216 can include instructions for receiving interaction data representing engagement and/or interactions of content consumers 112 with content distributed/published by content distributor 214, one or more interaction points inserted into content by interaction point module 208, one or more two-way engagement mechanisms inserted into content by two-way engagement engine 212, and/or two-way engagement mechanism data generated by two-way engagement engine 212. For example, interaction detector 216 can include instructions for receiving interaction data representing content consumers' 112 selection of two-way engagement mechanism data (e.g., clicking of a link) and/or text, images, audio, and/or video entered by content consumers 112 into one or more two-way engagement mechanisms (e.g., content consumers 112 questions, responses, requests, etc.).

In some examples, interaction detector 216 can further include instructions for receiving session data (e.g., the time content consumers 112 spend viewing distributed content and/or specific portions of the distributed content), click data (e.g., where and what content consumers 112 click on the content, where and what content consumers 112 click on the two-way engagement mechanisms, etc.), consumer source history, private data (e.g., data such as race, ethnicity, gender, sexual orientation, etc. anonymously shared by content consumers 112 and/or authorized third-party providers), and public data regarding content consumers 112 and content consumer devices 114 (e.g., public demographic data and/or specifications, operating system, browser, IP-address, etc. of content consumer devices 114). Further, in some examples, interaction detector 216 can include instructions for associating received interaction data with the specific channels content consumers 112 accessed the distributed/published content on.

Metrics/Analytics generator 218 can include instructions for generating metrics and/or analytics based on interaction data received by interaction detector 216. Metrics/Analytics generator 218 can further include instructions for generating metrics and/or analytics based on interaction data processed by two-way engagement engine 212. In some examples, metrics may include measurements of content consumers' 112 engagement and/or interactions with content such as click locations while viewing content, clicks over time, geographic distributions of content consumers 112, average time spent viewing content, amount of content consumers 112 viewing content per hour, engagement rate, conversation rate, conversation topics, success of predefined objective, common questions, etc. In some examples, analytics may include mathematical and statistical operations of content consumers' 112 engagement and/or interactions with content such as conversion rate of content consumers 112 visiting users 108 websites while or after viewing content to perform some objective (e.g., providing users 108 with contact information, purchasing products from users 108, etc.), content editor suggestions based on frequency of questions asked by content consumers 112 about specific entities or key phrases, consumer journey graphs, etc. In some examples, the processes used by metrics/analytics generator 218 to generate metrics and/or analytics may vary based on the goals or objectives of users 108 and/or the questions users 108 want answered. Metrics/Analytics generator 218 can further include instructions for relaying the metrics and/or analytics it generates to learning module 222.

Learning module 222 can include instructions for one or more AI learning models. Specifically, in some examples, learning module 222 can include instructions for one or more machine learning models. Learning module 222 can further include instructions for receiving data, information, and/or content from user database 202, receiving users 108 input from content analyzer 206, and/or receiving metrics and/or analytics from metrics/analytics generator 218. In some examples, learning module 222 can include instructions for training the one or more machine learning models using the data, information, content, users 108 input, and/or metrics and/or analytics it receives. Further, learning module 222 can include instructions for instructing—based on the training of the one or more machine learning models—one or more server system 102 modules to modify one or more of their functions, processes, and/or outputs.

For example, learning module 222 can include instructions for instructing one or more server system 102 modules to modify one or more of their functions, processes, and/or outputs based on the training of the one or more machine learning models using metrics and/or analytics generated by metrics/analytics generator 218. Learning module 222 can further include instructions for instructing—based on the training of the one or more machine learning models one or more server system 102 modules to perform, or refrain from performing, one or more actions, functions, and/or processes. For example, learning module 222 can include instructions for instructing one or more server system 102 modules to perform, or refrain from performing, one or more actions, functions, and/or processes based on the training of the one or more machine learning models using metrics and/or analytics generated by metrics/analytics generator 218.

For example, learning module 222 may include instructions for instructing content analyzer 206 to modify its content analysis (e.g., modifying the identification of key phrases and/or entities by content analyzer 206). Additionally or alternatively, learning module 222 may include instructions for instructing interaction point module 208 to modify one or more of the interaction points it has previously inserted in content. Additionally or alternatively, learning module 222 may include instructions for instructing two-way engagement engine 212 to modify one or more two-way engagement mechanisms it has previously inserted in content and/or the two-way engagement mechanism data it generates. Additionally or alternatively, learning module 222 may include instructions for instructing tag module 210 to modify one or more tags it has previously tagged on content. Additionally or alternatively, learning module 222 may include instructions for instructing content generator/modifier 220 to modify content previously distributed/published by content distributor 214. Additionally or alternatively, learning module 222 may include instructions for instructing content generator/modifier 220 to create content.

Content generator/modifier 220 can include instructions for modifying distributed/published content based on instructions received from learning module 222. For example, content generator/modifier 220 can include instructions for dynamically modifying distributed/published content based on instructions received from learning module 222 (e.g., modifying distributed/published content in real-time). Content generator/modifier 220 can further include instructions for generating content based on instructions received from learning module 222. For example, content generator/modifier 220 can include instructions for dynamically generating content based on instructions received from learning module 222 (e.g., generating content in real-time for A/B testing).

Processes for Topically-Relevant Two-Way Engagement with Content Consumers

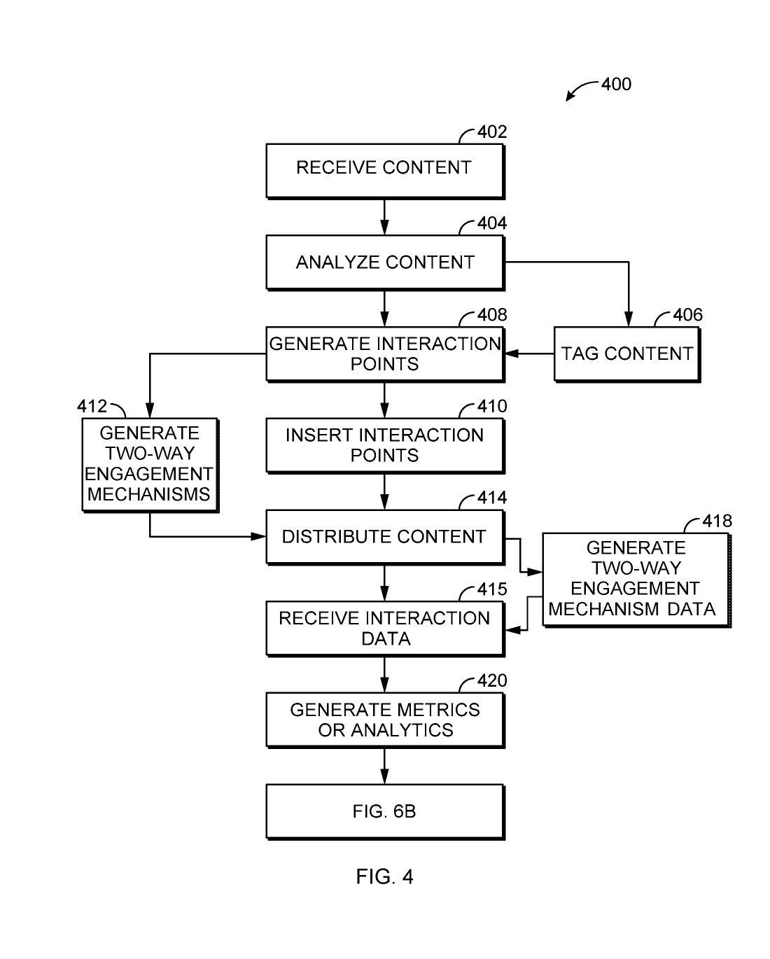

FIG. 4 illustrates an exemplary process implemented by a content development and distribution system for topically-relevant two-way engagement with content consumers according to various examples. In some examples, process 400 can be performed by a system similar or identical to system 100, shown in FIG. 1. In these examples, the blocks of process 400 can be performed by server system 102.

At block 402, one or more servers can receive content. In some examples, the one or more servers (e.g., server system 102) can receive content over a network (e.g., network 104) from one or more devices (e.g., user devices 110). For example, the one or more servers can receive content over the Internet, an intranet, or any other wired or wireless public or private network. In some examples, the one or more servers can receive content from one or more devices (over a network) that is created, modified, and/or uploaded via a SaaS interface (e.g., SaaS interface 106). For example, the one or more servers may receive content created and/or modified via the SaaS interface by one or more users of the system (e.g., users 108). Alternatively or additionally, the one or more servers may receive content created outside of the SaaS interface and uploaded via the SaaS interface by one or more users of the system. In some examples, the one or more servers can receive content (over a network) that is created, modified, and/or uploaded via one or more third-party content development and distribution platforms.

At block 404, the one or more servers can analyze content received at block 402 to identify one or more key phrases and/or one or more entities, wherein the one or more key phrases and one or more entities correspond to one or more topics. As explained above, “entities” are proper nouns and proper names that refer to real-world and/or fictional objects like people, places, companies, or products. Entities can also be explicit measurements such as dates and times and quantifiable amounts like numbers, bytes, currency, etc. “Key phrases” are one or more words that describe, identify, and/or distinguish one or more nouns (i.e., key phrases are noun descriptors). In some examples, entities can be subsets of key phrases, so a key phrase might consist of one or more entities and/or descriptors or could simply be an entity. In some examples, key phrases are iterable in that they are a continuously detectable set of descriptors of preceding or following key phrases.

At block 406, the one or more servers and/or the one or more users of the system can tag content analyzed at block 404 with one or more tags. For example, the one or more servers can tag content with one or more tags based on one or more key phrases, one or more entities, and/or one or more topics identified at block 404. Additionally or alternatively, the one or more users of the system can tag the content analyzed at block 404 with one or more tags via the SaaS interface. In some examples, tags may represent searchable metadata. For example, tags may represent searchable metadata that is topically related to the content on which it is tagged. Additionally or alternatively, tags may represent searchable metadata versions, alternatives, mentions, references, other names, related words, etc. of the key phrases and/or entities identified at block 404.

At block 408, the one or more servers can generate one or more interaction points based on the one or more key phrases, one or more entities, and/or one or more topics identified at block 404. In some examples, the one or more servers can generate one or more interaction points further based on the one or more tags tagged on content at block 406 (i.e., based on one or more key phrases, entities, topics, and/or tags).

At block 410, the one or more servers can insert the one or more interaction points generated at block 408 into the content analyzed at block 404. For example, the one or more servers can plug in and/or embed one or more interaction points into the content analyzed at block 404. Additionally or alternatively, the one or more servers can associate one or more interaction points with at least a portion of content. In some examples, the one or more servers can insert one or more interaction points as selectable links within the content analyzed at block 404 such that once the content is distributed/published (as explained in further detail below), one or more content consumers (e.g., content consumers 112) can activate/interact with the one or more interaction points by clicking and/or triggering the selectable links via their devices (e.g., content consumer devices 114). For example, the one or more servers can place one or more interaction points (i.e., as one or more selectable links) adjacent to one or more corresponding key phrases and/or entities identified at block 404. Additionally or alternatively, the one or more servers can place one or more interaction points (i.e., as one or more selectable links) adjacent to one or more paragraphs that correspond to one or more topics that the one or more key phrases and/or entities identified at block 404 correspond to. Additionally or alternatively, the one or more servers can turn the content text itself (e.g., one or more letters, words, and/or phrases, one or more of the identified key phrases and/or entities, etc.) into corresponding interaction points (i.e., as one or more selectable links).

In some examples, the one or more servers can insert one or more interaction points into the content analyzed at block 404 as background interaction points. For example, instead of appearing as selectable links within the content, the one or more servers can associate one or more interaction points with one or more words, sentences, and/or paragraphs within the content such that once the content is distributed/published (as explained in further detail below), the one or more content consumers can activate/interact with the one or more interaction points simply by engaging with and/or viewing the one or more words, sentences, and/or paragraphs via their devices.

At block 412, the one or more servers can generate one or more two-way engagement mechanisms based on the one or more interaction points generated at block 408. For example, the one or more servers can generate one or more chat engagements, video engagements, audio engagements, and/or virtual reality engagements based on one or more interaction points generated at block 408. In some examples, the one or more two-way engagement mechanisms can comprise two-way engagement mechanism data that is related to the one or more interaction points generated at block 408. For example, a chat engagement can comprise chat engagement data that is related to the one or more interaction points generated at block 408. In some examples, chat engagement data may include text, audio, and/or video, and/or links to webpages, documents, audio files, video files, and/or any other resources available over a network.

In some examples, the one or more servers can insert one or more two-way engagement mechanisms into content that contains one or more inserted interaction points. For example, the one or more servers can plug in and/or embed one or more two-way engagement mechanisms (e.g., one or more chat engagements) into content that contains one or more inserted interaction points. In some examples, the one or more servers can insert one or more two-way engagement mechanisms into content that contains one or more inserted interaction points such that once the content is distributed/published (as explained in further detail below), the one or more two-way engagement mechanisms can overlay at least a portion of the content in response to the one or more content consumers activating/interacting with one or more of the inserted interaction points via their devices. For example, the one or more servers can insert one or more chat engagements into content that contains one or more inserted interaction points such that once the content is distributed/published (as explained in further detail below), the one or more chat engagements can overlay at least a portion of the content in response to the one or more content consumers activating/interacting with one or more of the inserted interaction points via their devices.

At block 414, the one or more servers can distribute/publish content that contains one or more inserted interaction points and/or two-way engagement mechanisms over network 104 such that the one or more consumers can access, view, and/or interact with the content via their devices. In some examples, the one or more servers can also broadcast content that contains one or more inserted interaction points and/or two-way engagement mechanisms over network 104 to one or more channels. In some examples, the one or more servers can translate content that contains one or more inserted interaction points and/or two-way engagement mechanisms into one or more templates that are compatible with the one or more channels and allow the one or more content consumers visiting the one or more channels to access, view, and/or interact with the content over a network.

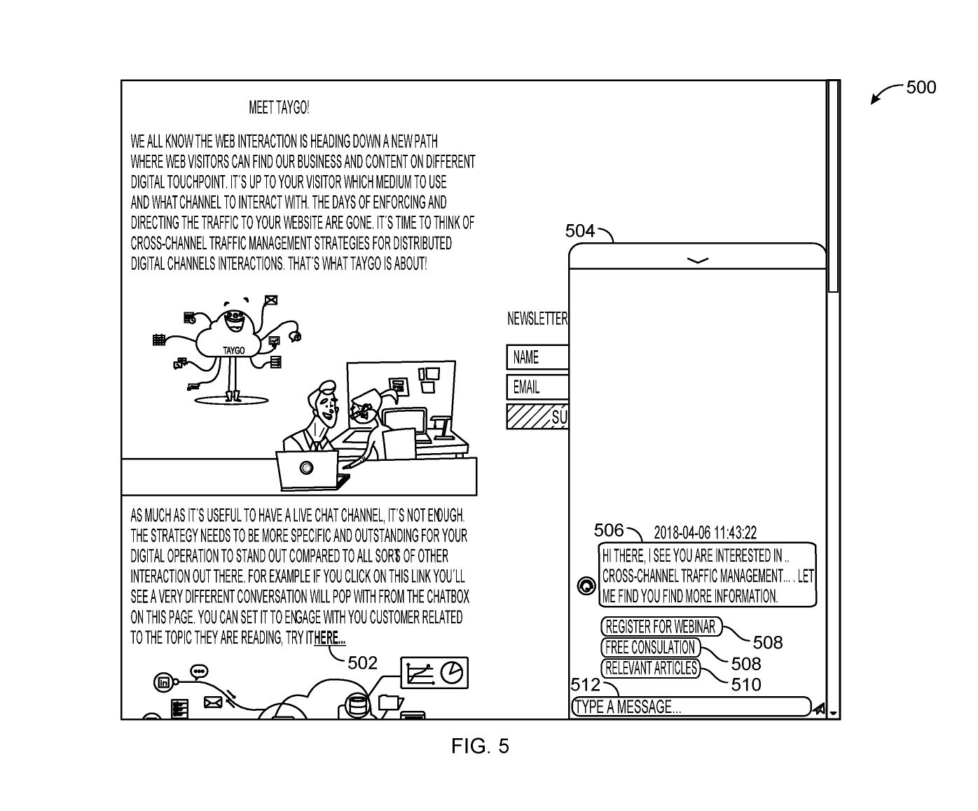

FIG. 5 illustrates an exemplary chat engagement interface overlaying a portion of content according to various examples. As shown, distributed/published content 500 can include interaction point 502 and chat engagement 504, which can comprise chat engagement data 506, 508, and 510 as well as message bar 512. In some examples, the one or more servers can turn the text of content 500 (e.g., “HERE . . . ”) into a corresponding interaction point (e.g., interaction point 502). In some examples, the one or more content consumers can activate/interact with interaction point 502 by clicking the selectable link (i.e., “HERE . . . ”) via their devices. In some examples, in response to the one or more content consumers activating/interacting with interaction point 502 via their devices, chat engagement 504 can pop up and overlay at least a portion of content 500.

In some examples, chat engagement 504 can comprise chat engagement data. In some examples, chat engagement data can include text (e.g., chat engagement data 506), links to webpages (e.g., chat engagement data 508), and links to documents (e.g., chat engagement data 510). In some examples, chat engagement 504 can comprise chat engagement data soon after chat engagement 504 pops up and overlays at least a portion of content 500. As will be explained in further detail below, the one or more content consumers can interact with chat engagement 504 and/or chat engagement data 506, 508, and 510. For example, the one or more content consumers can enter text into message bar 512 (via their devices) that represents one or more responses to chat engagement data 506, 508, and/or 510, one or more questions, and/or one or more requests (the questions and/or requests can be unrelated to chat engagement data 506, 508, and/or 510). Additionally or alternatively, the one or more consumers can select chat engagement data 508 and/or chat engagement data 510 (e.g., by clicking chat engagement data 508 and/or chat engagement data 510).

Although not shown in FIG. 5, in some examples, the one or more servers can generate a response to the one or more content consumers' responses, questions, and/or requests such that the live and conversational interaction with the one or more content consumers (i.e., two-way engagement) can continue for as long as the one or more content consumers desire. For example, in response to the one or more content consumer responses, questions, and/or requests, the one or more servers can generate and display (in chat engagement 504) additional chat engagement data (e.g., text and/or links). Additionally or alternatively, in response to the one or more content consumer responses, questions, and/or requests, the one or more servers can perform one or more actions (e.g., make a reservation, place an order for a product, etc.).

Notably, as a result of the one or more servers performing the process 400 steps explained above (i.e., analyzing content, identifying key phrases and/or entities, generating interaction points based on one or more key phrases, entities, topics and/or tags, and generating two-way engagement mechanisms and two-way engagement mechanism data based on interaction points) two-way engagement mechanism data can be topically related to content. For example, as shown in FIG. 5, chat engagement data 506, 508, and 510 are topically-related to content 500 (i.e., they are similarly related to “CROSS-CHANNEL TRAFFIC MANAGEMENT”). Responses to the one or more content consumers' responses, questions, and/or requests (not shown in FIG. 5) can similarly be topically-related to content 500. This in turn facilitates topically-relevant two-way engagement with content consumers.

Thus, when compared to existing two-way engagement platforms that implement expensive and inefficient AI learning platforms/models (e.g., machine learning platforms/models) that are unable to provide content consumers with topically-relevant, real-time two-way engagement (e.g., topically relevant, real-time interactions such as responses and actions), the systems described herein deliver a more engaging, informative, and useful two-way engagement experience for content consumers. Further, unlike many of the existing two-way engagement platforms that implement large content consumer messaging support teams (and thus can potentially provide topically-relevant two-way engagement), the systems described herein provide a topically-relevant, real-time two-way engagement experience for content consumers that is much more cost-efficient for the systems' users. Moreover, unlike existing two-way engagement platforms, the systems described herein can utilize a guided engagement approach (via topically-relevant two-way engagement) to increase the chances of achieving the goals of content providers and advertising/marketing operations. For example, the systems described herein can guide content consumers—via topically-relevant two-way engagement—to perform certain actions that content providers and/or advertising/marketing operations want content consumers to perform (e.g., signing up for certain online services, signing up for certain newsletters, purchasing certain products, making reservations at certain restaurants, visiting certain websites, etc.).

Referring again to process 400 of FIG. 4, at block 416, the one or more servers can receive interaction data representing engagement and/or interactions of the one or more content consumers with the content distributed/published at block 414 and/or the one or more interaction points and/or two-way engagement mechanisms that the content contains. For example, interaction data can represent session data (e.g., the time content consumers 112 spend viewing distributed content and/or specific portions of the distributed content), click data (e.g., where and what content consumers 112 click on the content, where and what content consumers 112 click on the two-way engagement mechanisms, etc.), consumer source history, private data (e.g., data such as race, ethnicity, gender, sexual orientation, etc. anonymously shared by content consumers 112 and/or authorized third-party providers), two-way engagement mechanism conversation logs, and public data regarding content consumers 112 and content consumer devices 114 (e.g., public demographic data and/or specifications, operating system, browser, IP-address, etc. of content consumer devices 114).

In some examples, the one or more servers can receive interaction data representing interactions of the one or more content consumers with one or more chat engagements that the content contains. In some examples, the one or more servers can also receive interaction data representing interactions of the one or more content consumers with two-way engagement mechanism data. For example, the one or more servers can receive interaction data representing interactions of the one or more content consumers with chat engagement data. In some examples, the interactions of the one or more content consumers with chat engagement data can comprise the one or more content consumers selecting the chat engagement data (e.g., clicking a link) and/or entering text (via their devices) into one or more chat engagements (e.g., entering questions, responses, requests, etc.). For example, the one or more content consumers can enter text into one or more chat engagements by manually typing the text using their devices and/or by speaking into their devices and having their devices enter the text (e.g., using speech-to-text conversion processes). In some examples, the one or more servers can associate received interaction data with the specific channels the one or more content consumers accessed the distributed/published content on.

At block 418, the one or more servers can process interaction data, generate two-way engagement mechanism data based on processed interaction data, and/or perform one or more actions based on processed interaction data. For example, the one or more servers can process text entered by the one or more content consumers into one or more chat engagements (e.g., content consumer questions, responses, requests, etc.), generate chat engagement data based on the processed text (e.g., responses to content consumer questions, responses, requests, etc.), and/or perform one or more actions based on the processed text (e.g., make a reservation, place an order for a product, etc.).

In some examples, the one or more servers can process interaction data (e.g., using natural language processing (“NLP”)) to detect one or more intents of the one or more content consumers and/or to extract one or more entities from the interaction data. Intents can be predefined by the system and/or created by the one or more users. Additionally, intents can define a link between interaction data received by the one or more servers, two-way engagement mechanism data generated by the one or more servers, and/or actions performed by the one or more servers. In some examples, the one or more servers can generate two-way engagement mechanism data (e.g., using natural language generation (“NLG”)) based on the one or more detected intents of the one or more content consumers and/or the one or more extracted entities. In some examples, the one or more servers can perform one or more actions based on the one or more detected intents of the one or more content consumers and/or the one or more extracted entities. In some examples, the one or more servers can generate two-way engagement mechanism data using NLG based on one or more actions the one or more servers perform and/or attempt to perform.

At block 420, the one or more servers can generate metrics and/or analytics based on the interaction data. For example, the one or more servers can generate metrics and/or analytics based on interaction data received at block 416 and/or processed interaction data (i.e., interaction data processed at block 418). In some examples, metrics may include measurements of the one or more content consumers' engagement and/or interactions with distributed/published content such as click locations while viewing the content, clicks over time, geographic distributions of the one or more content consumers, average time spent viewing the content, amount of content consumers viewing the content per hour, conversation logs, conversation rate, content consumer questions, etc. In some examples, analytics may include mathematical and statistical operations of the one or more content consumers' engagement and/or interactions with distributed/published content such as conversion rate of the one or more content consumers visiting the one or more users' websites while or after viewing the content to perform some objective (e.g., providing the one or more users with contact information, purchasing products from the one or more users, etc.), content editor suggestions based on frequency of questions asked by the one or more content consumers about one or more specific entities or key phrases, consumer journey graphs, etc. In some examples, the processes used by the one or more servers to generate metrics and/or analytics may vary based on the goals or objectives of the one or more users and/or the questions the one or more users want answered.

### Processes for Unsupervised, Semi-Supervised, and Supervised Training of Machine Learning Models Within a Content Development and Distribution System

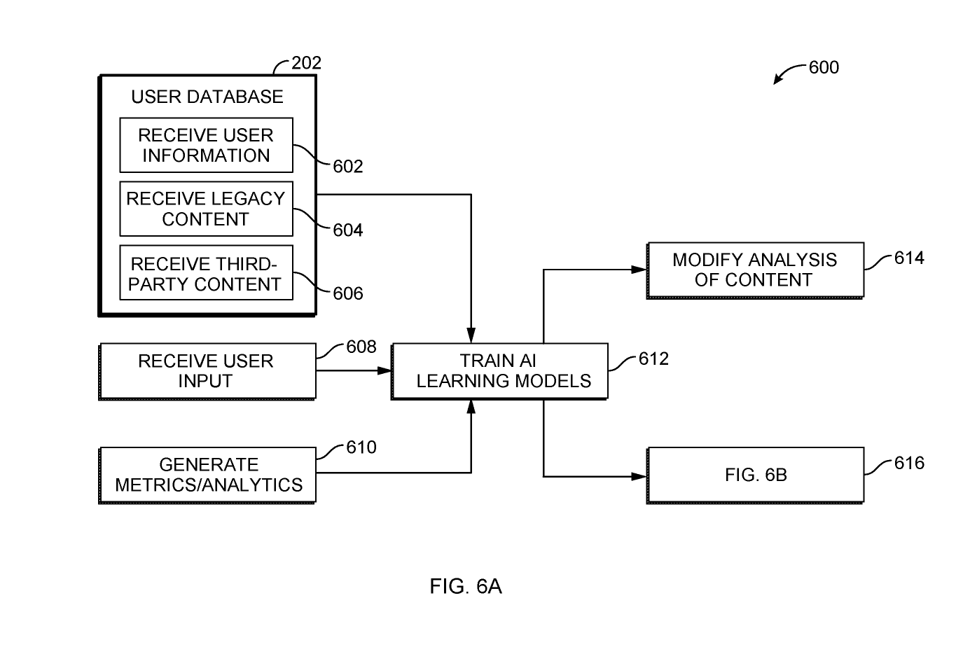

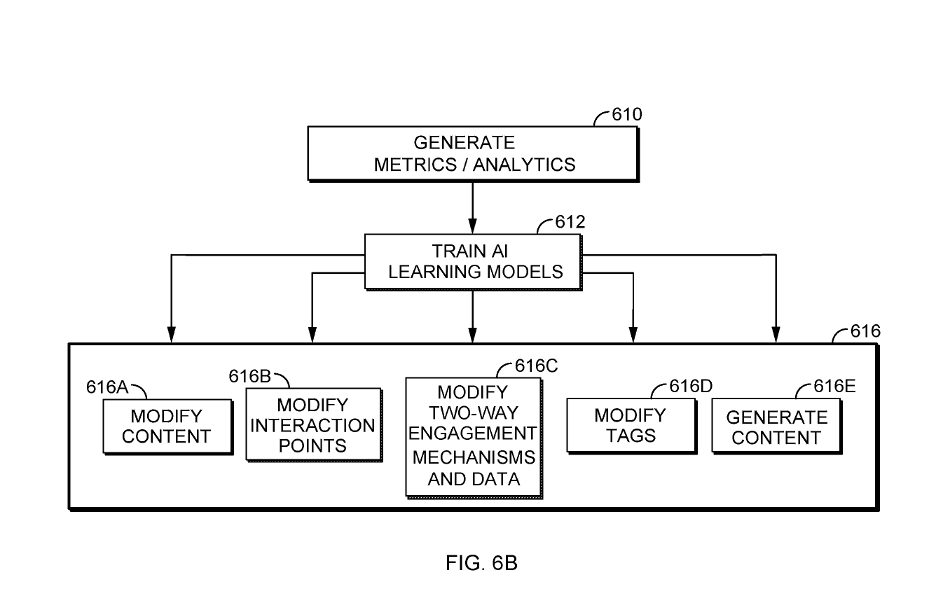

FIG. 6A illustrates a block diagram of an exemplary process for training the content development and distribution system machine learning models as well as exemplary results of the training. In some examples, process 600 can be performed by a system similar or identical to system 100, shown in FIG. 1. In these examples, the blocks of process 600 can be performed by server system 102.

At block 602, one or more servers (e.g., server system 102) can receive user information. In some examples, user information can include one or more users' (e.g., users 108) names, professions, companies, locations, demographics, etc. In some examples, the one or more servers can receive user information over a network (e.g., network 104) from one or more devices (e.g., user devices 110). For example, the one or more servers can receive content over the Internet, an intranet, or any other wired or wireless public or private network. In some examples, the one or more servers can receive user information from one or more devices (over a network) that is uploaded by the one or more users when creating a user account for the system via a SaaS interface (e.g., SaaS interface 106). In some examples, the one or more servers can store user information. For example, the one or more servers can store user information in user database 202.

At block 604, the one or more servers can receive legacy content and/or data. In some examples, legacy content can include older content created by the one or more users prior to creating a user account for the system and/or content created and/or modified by the one or more users using one or more third-party content development systems. In some examples, the one or more servers can receive legacy content and/or data over a network from the one or more users via their devices. For example, the one or more users can upload legacy content to the one or more servers via the SaaS interface. In some examples, the one or more servers can store legacy content and/or data. For example, the one or more servers can store legacy content and/or data in user database 202. In some examples, the one or more servers can associate stored legacy content with the one or more users that uploaded the legacy content.

At block 606, the one or more servers can receive third-party content and/or data. In some examples, third-party content can include documents, articles, books, data, etc. that may not have been created and/or modified by the one or more users that provide the system with the content. In some examples, the one or more servers can receive third-party content and/or data over a network from the one or more users via their devices. For example, the one or more users can upload third-party content and/or data to the one or more servers via the SaaS interface. In some examples, the one or more servers can store third-party content and/or data. For example, the one or more servers can store third-party content and/or data in user database 202. In some examples, the one or more servers can associate stored third-party content and/or data with the one or more users that uploaded the legacy content.

At block 608, the one or more servers can receive input from the one or more users. In some examples, the one or more servers can receive input from the one or more users over a network. For example, the one or more users can provide input using their devices via the SaaS interface. In some examples, input from the one or more users can represent an approval and/or rejection of one or more entities and/or key phrases (e.g., the one or more entities and/or key phrases identified at block 404 in FIG. 4). Alternatively or additionally, input from the one or more users can define a semantic relationship between one or more entities and a portion of content, one or more other entities, and/or one or more key phrases. Alternatively or additionally, input from the one or more users can define a semantic relationship between one or more key phrases and a portion of content, one or more other key phrases, and/or one or more entities.

At block 610, the one or more servers can generate metrics and/or analytics (e.g., the metrics and/or analytics generated at block 420 in FIG. 4). In some examples, metrics may include measurements of the one or more content consumers' engagement and/or interactions with distributed/published content such as click locations while viewing the content, clicks over time, geographic distributions of the one or more content consumers, average time spent viewing the content, amount of content consumers viewing the content per hour, conversation logs, consumer questions, etc. In some examples, analytics may include mathematical and statistical operations of the one or more content consumers' engagement and/or interactions with distributed/published content such as conversion rate of the one or more content consumers visiting the one or more users' websites while or after viewing the content to perform some objective (e.g., providing the one or more users with contact information, purchasing products from the one or more users, etc.), content editor suggestions based on frequency of questions asked by the one or more content consumers about one or more specific entities or key phrases, consumer journey graphs, etc.

Note, the one or more servers are not required to receive user information, legacy content and/or data, third-party content and/or data, and input from the one or more users, and generate metrics and/or analytics in the order presented above and in FIG. 6A. Rather, the one or more servers can receive user information, legacy content and/or data, third-party content and/or data, and input from the one or more users in any order and/or at the same time. Further, the one or more servers can generate metrics and/or analytics before, after, and/or while receiving user information, legacy content and/or data, third-party content and/or data, and input from the one or more users.

At block 612, the one or more servers can train one or more machine learning models (e.g., the one or more machine learning models of learning module 222 in FIG. 2). In some examples, the one or more servers can train the one or more machine learning models using data, information, and/or content received by the one or more servers and/or stored in the one or more servers. For example, the one or more servers can train the one or more machine learning models using the user information, legacy content and/or data, and/or third-party content and/or data received at blocks 602, 604, and 606 (respectively) and stored in the one or more servers (e.g., in user database 202). This type of training of the one or more machine learning models can comprise supervised and/or unsupervised training depending on the data, information, and/or content being used to train the one or more learning models and/or the objectives of the training. In some examples, unsupervised training of the one or more machine learning models can involve the use of statistics, statistical math, neural networks, etc. Notably, the training described above can improve the system in various ways.

In some examples, at block 614, the one or more servers can modify the analysis of content (e.g., the analysis of content performed at block 404 in FIG. 4) based on this supervised and/or unsupervised training of the one or more machine learning models. For example, the one or more servers can modify the analysis of the content such that the analysis more accurately identifies one or more key phrases and/or entities. Additionally or alternatively, the one or more servers can modify the analysis of content such that the analysis takes into account changes regarding one or more entities (e.g., name changes, changes to the one or more topics that the one or more entities correspond to, etc.), changes regarding semantic relationships between one or more entities and/or key phrases, changes to at least a portion of content, and/or current events. In some examples, the above modifications can be utilized in the analysis of content subsequently received by the one or more servers. In some examples, at block 616, the one or more servers can make one or more modifications to various aspects of the system and/or perform one or more actions based on this supervised and/or unsupervised training of the one or more machine learning models that can serve to improve the system as well as the content consumer two-way engagement experience. These one or more modifications and/or actions are explained in further detail below with respect to FIG. 6B.

In some examples, the one or more servers can train the one or more machine learning models using the input received from the one or more users at block 608. This type of training of the one or more machine learning models can comprise supervised and/or semi-supervised training depending on the extent the input received from the one or more users is being used to train the one or more learning models and/or the objectives of the training. Notably, this supervised and/or semi-supervised training can improve the system in various ways. In some examples, at block 614, the one or more servers can modify the analysis of content (e.g., the analysis of content performed at block 404 in FIG. 4) based on this supervised and/or semi-supervised training of the one or more machine learning models. For example, the one or more servers can modify the analysis of the content such that the analysis more accurately identifies one or more key phrases and/or entities. Additionally or alternatively, the one or more servers can modify the analysis of content such that the analysis takes into account changes regarding one or more entities (e.g., name changes, changes to the one or more topics that the one or more entities correspond to, etc.), changes regarding semantic relationships between one or more entities and/or key phrases, changes to at least a portion of content, and/or current events. In some examples, the above modifications can be utilized in the analysis of content subsequently received by the one or more servers. In some examples, at block 616, the one or more servers can make one or more modifications to various aspects of the system and/or perform one or more actions based on this supervised and/or semi-supervised training of the one or more machine learning models that can serve to improve the system as well as the content consumer two-way engagement experience. These one or more modifications and/or actions are explained in further detail below with respect to FIG. 6B.

In some examples, the one or more servers can train the one or more machine learning models using the metrics and/or analytics generated at block 610 (e.g., the metrics and/or analytics generated at block 420 in FIG. 4). This type of training of the one or more machine learning models typically only comprises unsupervised training, which (in some examples) involves the use of statistics, statistical math, neural networks, etc. Notably, this unsupervised training can improve the system in various ways. In some examples, at block 614, the one or more servers can modify the analysis of content (e.g., the analysis of content performed at block 404 in FIG. 4) based on this unsupervised training of the one or more machine learning models. For example, the one or more servers can modify the analysis of the content such that the analysis more accurately identifies one or more key phrases and/or entities. Additionally or alternatively, the one or more servers can modify the analysis of content such that the analysis takes into account changes regarding one or more entities (e.g., name changes, changes to the one or more topics that the one or more entities correspond to, etc.), changes regarding semantic relationships between one or more entities and/or key phrases, changes to at least a portion of content, and/or current events. In some examples, the above modifications can be utilized in the analysis of content subsequently received by the one or more servers. In some examples, at block 616, the one or more servers can make one or more modifications to various aspects of the system and/or perform one or more actions based on this unsupervised training of the one or more machine learning models that can serve to improve the system as well as the content consumer two-way engagement experience. These one or more modifications and/or actions are explained in further detail below with respect to FIG. 6B.

Although the above discussion describes the one or more servers as separately utilizing each type of supervised, semi-supervised, and unsupervised training of the machine learning models to modify the analysis of content at block 614 and make one or more modifications to various aspects of the system and/or perform one or more actions at block 616, in some examples, the one or more servers may utilize any combination of supervised, semi-supervised, and unsupervised training of the machine learning models to modify the analysis of content at block 614 and make one or more modifications to the system and/or perform one or more actions at block 616. For example, the one or more servers may train the machine learning models using user information received at block 602, legacy content and/or data received at block 604, third-party content and/or data received at block 606, input received from the one or more users at block 608, metrics generated at block 610, and analytics generated at block 610 and subsequently modify the analysis of content at block 614 and/or make one or more modifications to various aspects of the system and/or perform one or more actions at block 616 based on that training.

FIG. 6B illustrates a block diagram of exemplary functions of the process for training the content development and distribution system machine learning models shown in FIG. 6A according to various examples. Specifically, FIG. 6B illustrates exemplary modifications and/or actions the one or more servers can make/perform at block 616. Although FIG. 6B illustrates exemplary modifications and/or actions the one or more servers can make/perform at block 616 with respect to the one or more servers generating metrics and/or analytics at block 610, the one or more servers may also make/perform the exemplary modifications and/or actions at block 616 with respect to the user information received at block 602, the legacy content and/or data received at block 604, the third-party content and/or data received at 606, and/or the input received from the one or more users at block 608.

As explained above with respect to FIG. 6A, in some examples, the one or more servers can generate metrics/and or analytics (e.g., the metrics and/or analytics generated at block 420 in FIG. 4) at block 610. In some examples, the one or more servers can train one or more machine learning models (e.g., the one or more machine learning models of learning module 222 in FIG. 2) at block 612 using the metrics and/or analytics generated at block 610. In some examples, at block 616, the one or more servers can then make one or more modifications to various aspects of the system and/or perform one or more actions based on the training of the one or more machine learning models at block 612. These modifications and/or actions can serve to improve the system as well as the content consumer two-way engagement experience.

In some examples, at block 616A, the one or more servers can dynamically modify distributed/published content (e.g., distributed/published at block 414 in FIG. 4) based on the training of the one or more machine learning models at block 612 using the metrics and/or analytics generated at block 610. For example, the one or more servers can modify the distributed/published content by editing one or more words, sentences, and/or paragraphs and/or adding one or more words, sentences, and/or paragraphs. In some examples, the one or more servers can dynamically modify the distributed/published content to make it more engaging to content consumers. For example, the one or more servers can modify the content so that it addresses content consumer responses, questions, and/or requests (e.g., entered into message bar 512 in FIG. 5).

In some examples, at block 616B, the one or more servers can dynamically modify one or more interaction points previously inserted (e.g., inserted at block 410 in FIG. 4) into distributed/published content (e.g., distributed/published at block 414 in FIG. 4) based on the training of the one or more machine learning models at block 612 using the metrics and/or analytics generated at block 610. In some examples, dynamically modifying the one or more interaction points previously inserted into distributed/published content based on the training of the one or more machine learning models at block 612 using the metrics and/or analytics generated at block 610 comprises the one or more servers generating one or more additional interaction points and inserting the one or more additional interaction points into the distributed/published content. In some examples, dynamically modifying the one or more interaction points previously inserted into distributed/published content based on the training of the one or more machine learning models at block 612 using the metrics and/or analytics generated at block 610 comprises the one or more servers removing one or more of the interaction points previously inserted into distributed/published content. In some examples, modifying the one or more interaction points previously inserted into distributed/published content allows the system to generate new two-way engagement mechanisms (and/or two-way engagement mechanism data) based on the one or more modified interactions points that can more accurately and effectively respond to content consumer responses, questions, and/or requests.

In some examples, at block 616C, the one or more servers can dynamically modify one or more two-way engagement mechanisms and/or the generation of two-way engagement mechanism data by the one or more servers based on the training of the one or more machine learning models at block 612 using the metrics and/or analytics generated at block 610. For example, based on the training of the one or more machine learning models at block 612 using the metrics and/or analytics generated at block 610, the one or more servers can dynamically modify chat engagement data that the one or more servers generate in response to certain interactions, responses, questions, and/or requests of the one or more content consumers (i.e., in response to certain interaction data received and processed by the one or more servers).

For example, based on the training of the one or more machine learning models at block 612 using the metrics and/or analytics generated at block 610, the one or more servers can modify the processing of received interaction data (e.g., the natural language processing (“NLP”) of received interaction data) and thus modify chat engagement data the one or more servers generate based on the processed interaction data. Additionally or alternatively, based on the training of the one or more machine learning models at block 612 using the metrics and/or analytics generated at block 610, the one or more servers can dynamically modify one or more actions that the one or more servers perform in response to certain interactions, responses, questions, and/or requests of the one or more content consumers (i.e., in response to certain interaction data received and processed by the one or more servers). In some examples, the one or more servers can dynamically modify (based on the training of the one or more machine learning models at block 612 using the metrics and/or analytics generated at block 610) one or more intents and/or the detection of one or more intents (e.g., modifying the NLP used to detect one or more intents from interaction data) such that the one or more servers can more accurately detect intents (e.g., representing the desires, objectives, and/or needs of the one or more content consumers) from received interaction data. In some examples, modifying the generation of two-way engagement mechanism data (e.g., chat engagement data) by the one or more servers helps the system respond to content consumer responses, questions, and/or requests more accurately and effectively, and thus improves the content consumer two-way engagement experience (e.g., increases the system's success rate).

In some examples, at block 616D, the one or more servers can dynamically modify one or more tags previously tagged onto distributed/published content (e.g., distributed/published at block 414 in FIG. 4) based on the training of the one or more machine learning models at block 612 using the metrics and/or analytics generated at block 610. In some examples, the one or more users of the system can modify the one or more tags previously tagged onto distributed/published content via the SaaS interface. For example, the one or more users of the system can modify the one or more tags previously tagged onto distributed/published content based on the metrics and/or analytics generated at block 610. In some examples, modifying the one or more tags allows for content to be more easily found when content consumers search for, or inquire about, content (i.e., over a network) based on one or more entities, key phrases, and/or topics that the one or more servers have added to distributed/published content based on the training of the one or more machine learning models at block 612 using the metrics and/or analytics generated at block 610.

In some examples, at block 616E, the one or more servers can dynamically generate content based on the training of the one or more machine learning models at block 612 using the metrics and/or analytics generated at block 610. For example, the one or more servers can generate content that addresses content consumer responses, questions, and/or requests (e.g., entered into message bar 512 in FIG. 5).

Training one or more learning models using the systems and processes described above provides many benefits (in addition to those already described above). For example, the systems and processes described above solve a significant problem in computer science and natural language processing—Named Entity Recognition (“NER”). In summary, NER requires a large amount of properly annotated data to achieve high confidence scores, wherein confidence scores are determined based on properly finding all the entities in a text and properly determining how these entities relate to each other. By establishing a universal relational model with entities as the basis, higher level models can be designed in content (e.g., physical presentation of entities), topics (e.g., statistical distributions of entities in content), intention (e.g., querying on entity data sets), behavior (e.g., statistical functions of interest in entities and predicted actions), demographics (e.g., statistical distributions of entity types), and identities (e.g., federated entities) that are structurally well supported and thus increase the ability of all models to generate higher confidence scores in decisions, predictions, and classification. Accordingly, the systems and processes described above seamlessly integrate the process of NER annotation into the natural content development, distribution, and interaction lifecycle, and thus can increase the quality and success of engagement with content consumers.

Not only can these systems and processes provide solutions to AI learning model issues such as NER, they can help content providers and advertising/marketing operations improve their content creation, distribution, engagement, and analytics, as well as the chances of achieving their goals (i.e., via effective and guided engagement). For example, the systems and processes described herein can guide content consumers—via topically-relevant two-way engagement—to perform certain actions that content providers and/or advertising/marketing operations want content consumers to perform (e.g., signing up for certain online services, signing up for certain newsletters, purchasing certain products, making reservations at certain restaurants, visiting certain websites, etc.). Moreover, the systems and processes for training AI learning models (e.g., machine learning models) described above can continue to improve the guided engagement of content consumers by dynamically modifying the topically-relevant two-way engagement experience provided by the systems and processes (e.g., by modifying content, interaction points, two-way engagement mechanism data generated in response to content consumer interactions, etc.).

Although the above examples of the present invention, and various modifications thereof, are described with respect to machine learning models, it is to be understood that the present invention is not limited to utilizing only machine learning models. Rather, the present invention may additionally or alternatively utilize various forms of AI learning models, such as representation learning models, deep learning models, etc.

Additionally, although examples of the present invention, and various modifications thereof, have been fully described herein with reference to the accompanying drawings, it is to be understood that the present invention is not limited to these precise examples and modifications thereof, and that various changes and further modifications will become apparent to those skilled in the art. Such changes and further modifications are to be understood as being included within the scope of the present invention as defined by the appended claims.

What is claimed is:

1. A method for training one or more machine learning models comprising:
at one or more devices with one or more processors and a memory:
receiving content;
analyzing the content to identify one or more key phrases and one or more entities, wherein the one or more key phrases and the one or more entities correspond to one or more topics;
generating one or more interaction points based on the one or more key phrases, the one or more entities, and the one or more topics;
inserting the one or more interaction points into the content;
distributing the content with the one or more inserted interaction points to one or more consumers;
receiving interaction data, wherein the interaction data represents interactions of the one or more consumers with the content and the one or more interaction points;
generating metrics or analytics based on the interaction data; and
training the one or more machine learning models using the metrics or analytics.

2. The method of claim 1, further comprising:
receiving legacy content, user information, or third-party content;
training the one or more machine learning models using the legacy content, user information, or third-party content; and
modifying the analysis of the content based on the training of the one or more machine learning models .

3. The method of claim 1, further comprising:
receiving user input;
training the one or more machine learning models using the user input; and
modifying the analysis of the content based on the training of the one or more machine learning models.

4. The method of claim 3, wherein the user input represents one or more users approving at least one of the one or more entities or the one or more key phrases.

5. The method of claim 3, wherein the user input represents one or more users rejecting at least one of the one or more entities or the one or more key phrases.

6. The method of claim 3, wherein the user input represents one or more users defining a semantic relationship between at least one of the one or more entities and a portion of the content, at least one other entity of the one or more entities, or at least one of the one or more key phrases.

7. The method of claim 3, wherein the user input represents one or more users defining a semantic relationship between at least one of the one or more key phrases and a portion of the content, at least one other key phrase of the one or more key phrases, or at least one of the one or more entities.

8. The method of claim 1, further comprising:
modifying the analysis of the content based on the training of the one or more machine learning models.

9. The method of claim 1, further comprising:
tagging the content with one or more tags,
wherein the generation of the one or more interaction points is further based on the one or more tags.

10. The method of claim 1, further comprising:
tagging the content with one or more tags by a user of the system,
wherein the generation of the one or more interaction points is further based on the one or more tags.

11. The method of claim 1, wherein inserting the one or more interaction points into the content comprises:
placing the one or more interaction points adjacent to one or more corresponding key phrases or entities.

12. The method of claim 1, wherein inserting the one or more interaction points into the content comprises:
placing the one or more interaction points adjacent to one or more paragraphs,
wherein the one or more paragraphs correspond to at least one of the one or more topics.

13. The method of claim 1, wherein distributing the content with the one or more inserted interaction points to the one or more consumers comprises:
broadcasting the content to one or more channels.

14. The method of claim 13, wherein the one or more channels comprise a one-to-many broadcasting channel, a one-to-one private messaging channel, or a static webpage channel.

15. The method of claim 13, wherein broadcasting the content to the one or more channels comprises:
translating the content into one or more templates that are compatible with the one or more channels.

16. The method of claim 1, further comprising:
generating one or more chat engagements based on the one or more interaction points; and
generating chat engagement data related to the one or more interaction points,
wherein the one or more chat engagements comprise generated chat engagement data, and
wherein the interaction data further represents interactions of the one or more consumers with the chat engagement data.

17. The method of claim 16, wherein the one or more chat engagements overlay the content.

18. The method of claim 16, wherein the interactions of the one or more consumers with the chat engagement data comprise the one or more consumers selecting the chat engagement data or entering text into the chat engagement in response to the chat engagement data.

19. The method of claim 1, further comprising:
modifying the content based on the training of the one or more machine learning models.

20. The method of claim 1, further comprising:
generating new content based on the training of the one or more machine learning models.

21. The method of claim 1, further comprising:
modifying the one or more interaction points based on the training of the one or more machine learning models.

22. The method of claim 21, wherein modifying the one or more interaction points based on the training of the one or more machine learning models comprises:
generating one or more additional interaction points; and
inserting the one or more additional interaction points into the content.

23. The method of claim 21, wherein modifying the one or more interaction points based on the training of the one or more machine learning models comprises:
removing at least one of the one or more interaction points.

24. The method of claim 9, further comprising:
modifying the one or more tags based on the training of the one or more machine learning models.

25. The method of claim 10, further comprising:
modifying the one or more tags by the user of the system.

26. The method of claim 16, further comprising:
modifying a process for generating chat engagement data based on the training of the one or more machine learning models.

27. A non-transitory computer-readable storage medium storing one or more programs, the one or more programs comprising instructions, which when executed by one or more processors of one or more electronic devices, cause the one or more electronic devices to:
receive content;
analyze the content to identify one or more key phrases and one or more entities, wherein the one or more key phrases and the one or more entities correspond to one or more topics;
generate one or more interaction points based on the one or more key phrases, the one or more entities, and the one or more topics;
insert the one or more interaction points into the content;
distribute the content with the one or more inserted interaction points to one or more consumers;
receive interaction data, wherein the interaction data represents interactions of the one or more consumers with the content and the one or more interaction points;
generate metrics or analytics based on the interaction data; and
train one or more machine learning models using the metrics or analytics.

28. A system comprising:
one or more processors;
memory; and
one or more programs stored in the memory, the one or more programs including instructions for:
receiving content;
analyzing the content to identify one or more key phrases and one or more entities, wherein the one or more key phrases and the one or more entities correspond to one or more topics;
generating one or more interaction points based on the one or more key phrases, the one or more entities, and the one or more topics;
inserting the one or more interaction points into the content;
distributing the content with the one or more inserted interaction points to one or more consumers;
receiving interaction data, wherein the interaction data represents interactions of the one or more consumers with the content and the one or more interaction points;
generating metrics or analytics based on the interaction data; and
training one or more machine learning models using the metrics or analytics.
